(19) United States
(12) Patent Application Publication
(10) Pub. No.: US 2014/0372063 A1
(43) Pub. Date: Dec. 18, 2014

(54) Quick calibration method for inertial measurement unit

(71) Applicant: WUHAN UNIVERSITY, Wuhan, Hubei (CN)

(72) Inventors: Xiaoji Niu, Wuhan (CN); You Li, Wuhan (CN); Quan Zhang, Wuhan (CN); Chuanchuan Liu, Wuhan (CN); Hongping Zhang, Wuhan (CN); Chuang Shi, Wuhan (CN); Jingnan Liu, Wuhan (CN)

(21) Appl. No.: 14/239,145

(22) PCT Filed: Mar. 5, 2013
(86) PCT No.: PCT/CN2013/072202

§ 371 Date: Feb. 16, 2014

(30) Foreign Application Priority Data
Mar. 6, 2012 (CN) 201210056759.2

(51) Int. Cl. G01P 21/00

(52) U.S. Cl. CPC G01P 21/00
USPC 702/104; 702/189; 702/141

(57) ABSTRACT

The invention relates to a quick calibration method for an inertial measurement unit (IMU). According to the method, a user holds and rotates the IMU to move in all directions without any external equipment, so that twelve error coefficients including gyro biases, gyro scale factors, accelerometer biases and accelerometer scale factors can be accurately calibrated in a short time. The quick calibration method for the IMU is characterized by being free of hardware cost, high in efficiency and simple and easy to implement, and can ensure certain calibration precision. Thus, the quick calibration method is especially suitable for in-situ quick calibration for the medium- and low-grade IMUs, thereby effectively solving the problem of environmental sensitivity of the error coefficients of the mechanical IMU, and promoting popularization and application of MEMS (micro-electro mechanical systems) inertial devices.

### TECHNICAL FIELD

The invention relates to the technical field of micro-electro mechanical systems (MEMS), especially to a quick calibration method for an inertial measurement unit (IMU).

### BACKGROUND ART

With development of the MEMS technology in recent years, an MEMS IMU which has the advantages including low cost (in batch production), small size, low weight, low power consumption and high reliability is generated, and can be widely applied to different aspects in daily life. Tri-axial gyros and accelerometers are installed in more and more consumer electronics to form the MEMS IMUs so that various applications such as games, multimedia and personal navigation can be selected according to personal interests.

The obvious problem that error coefficients (especially biases and scale factors) of MEMS sensors change greatly with the use environment (especially temperature) can be solved by calibration, i.e., the error coefficients of the sensor can be determined via calibration and compensated during the using process of the IMU.

Most traditional calibration methods depend on specialized calibration equipment or take relatively long time, which can hardly satisfy requirements of independence from external equipment, rapidness and simpleness, and easy to implement for the consumer electronics.

### SUMMARY OF THE INVENTION

The invention aims at providing a quick calibration method for an IMU, which can calibrate the IMU without any external equipment or reference. The precision of inertial sensors whose biases and scale factors are calibrated via the method is improved.

The quick calibration method for the IMU comprises the following steps that:

Step 1) after an inertial measurement system is warmed up, whether initial horizontal attitude angles of the IMU are known is determined. If yes, moving to Step 3; and if no, moving to Step 2;

Step 2) the IMU is maintained in a static state for a period and the initial horizontal attitude angle of the IMU is calculated approximately according to measurement information of the accelerometers and the gyros during the period;

Step 3) an initial heading angle of the IMU is set at random; and

Step 4) the IMU is rotated around a measurement center thereof, and to-be-estimated gyro and accelerometer error coefficients are calculated based on the known initial horizontal attitude angles or the initial horizontal attitude angles obtained in Step 2 and the initial heading angle obtained in Step 3, wherein during calculation, position variation and velocity variation of the IMU are both set as zero, and respectively represent pseudo-position observation information and pseudo-velocity observation information.

Processes of maintaining the IMU in the static state in Step 2 and rotating the IMU around the measurement center thereof in Step 4 are realized via manual operation or by means of using other equipment and machines.

Calibration calculation in Step 4 is realized by the Kalman filter algorithm, particularly comprising:

Step 4.1) modeling the whole calculation process of the Kalman filter algorithm to obtain calibration models, setting initial values of the parameters in the calibration models based on the known initial horizontal attitude angle or the initial horizontal attitude angle obtained in Step 2 and the initial heading angle obtained in Step 3, and initializing the calibration algorithm;

Step 4.2) rotating the IMU around the measurement center thereof, and processing data in real time via the calibration models;

Step 4.3) judging whether the to-be-estimated IMU error coefficients converge to a corresponding preset precision; if yes, moving to Step 4.4, and if no, continuing implementing Step 4.2;

Step 4.4) after completion of calibration, moving to Step 4.5 directly, or moving to Step 4.5 after once backward data smoothing; and

Step 4.5) obtaining the to-be-estimated gyro and accelerometer error coefficients after calibration.

The quick calibration method for the IMU has the following technical affects that:

1) The calibration method does not require any equipment or device to assist calibration. Calibration motion needs not to be strictly defined, wherein the calibration can be completed by holding the IMU in hand and rotating the IMU around the measurement center thereof sufficiently without precision requirements, and guidance can be provided to further improve calibration efficiency and precision;

2) The calibration method can relatively accurately calibrate accelerometer biases and scale factors and gyro biases and scale factors in a short period (about 30 sec); and according to the guidance, the time can be further shortened;

3) A GPS (Global Positioning System) and INS (Inertial Navigation system) integrated navigation algorithm is utilized in the calibration method to calibrate biases and scale factors of medium- and low-grade IMU sensors. The pseudo-observation information is used to replace GPS measurement information to complete parameter estimation;

4) Pseudo-observation information which comprises the pseudo-position observation information and pseudo-velocity observation information is the key to the calibration method. It is presumed that position and linear velocity of the IMU respectively vary within limited ranges. One or both selected from the pseudo-position observation information and the pseudo-velocity observation information can be used as the measurement information. The variation ranges of the position and velocity can be reflected in a measurement error matrix of the system, wherein the variation ranges can be set according to practical operation states, or adaptively completed by programs. Due to employment of the pseudo-position observation information and pseudo-velocity observation information, it is not required to keep the IMU in the static states for some period at each of different attitudes as in most calibration methods, thereby improving calibration efficiency and convenience. Besides the aforementioned pseudo-position observation information and pseudo-velocity observation information, other motion characteristics of the IMU during calibration process can be also used as pseudo-observation information;

5) A series of guidelines is provided on the basis of the calibration method. A user does not have to implement operations in strict accordance with the guidelines; however, the guidelines are helpful for substantially improving the calibration efficiency. The guidelines are given on the basis of observability analysis which estimates different sensor error coefficients in different motions;

6) The algorithm can make use of an optimal method or a suboptimal estimation method (according to user interests), such as Kalman Filter, Least Squares (or Weighted Least Squares) or other estimation means;

7) It is reflected that the accelerometers and the gyros can calibrate each other, i.e., an accelerometer combination and a gyro combination can be seen as two systems, not only measurement information of the accelerometers can be used for calibrating and correcting gyro error coefficients, but also measurement information of the gyros can be used for calibrating and correcting accelerometer error coefficients;

8) If the Kalman Filter or the Recursive Least Squares is used for estimation, the algorithm is used continuously to estimate, feedback and correct the accelerometer biases and scale factors and the gyro biases and scale factors in real time during rotation; and after completion of calibration the moment rotation is completed, and post-processing is not required. If the backward smoothing is carried after completion of rotation, precision of the result can be further improved. If other estimation means is selected, the estimated IMU error coefficients can be resolved within a short time after completion of motion of the user;

9) The IMU provided by the invention can be an low-grade MEMS IMU, or an IMU composed of inertial sensors (i.e., the gyros and the accelerometers) in other grades, wherein the IMU can be an IMU commonly composed of a tri-axial gyro and a tri-axial accelerometer, and an IMU equipped with redundancy configuration or incomplete axial configuration, or even a single-axial inertial sensor is further included; and

10) The calibration method of the invention is not limited to manual calibration. Instead, the calibration method also includes calibration which uses external equipment (e.g. a turntable) to generate calibration motions.

### BRIEF DESCRIPTION OF THE DRAWING

FIG. 1 shows a flowchart of an embodiment of the invention.

### DETAILED DESCRIPTION OF THE PREFERRED EMBODIMENTS

A quick calibration method for an IMU comprises that the IMU is kept in a static or quasi-static state for a short time (several seconds) for initial alignment of an INS; the IMU is rotated around (or approximately around) the measurement center thereof in a space; an estimation method is selected, and modeling is carried out according to the estimation method; pseudo-position or pseudo-velocity information is used as measurement information to carry out estimation and calculation; IMU error coefficients are obtained; and the IMU can get into a normal work state after subsequent directly-measured values of a gyro and an accelerometer are compensated. Operation of the IMU can be carried out manually, or be implemented via other external equipment (e.g. a turntable). The method of the invention is used for calibrating the IMU. The IMU provided in the invention can be an low-grade MEMS IMU, or an IMU composed of inertial sensors (i.e., the gyros and the accelerometers) in other precision level, wherein the IMU can be an IMU commonly composed of a tri-axial gyro and a tri-axial accelerometer, and an IMU equipped with redundancy configuration or incomplete axial configuration, or even a single-axial inertial sensor is included. The IMU can be also a multi-sensor combined navigation system consisting of other types of sensors.

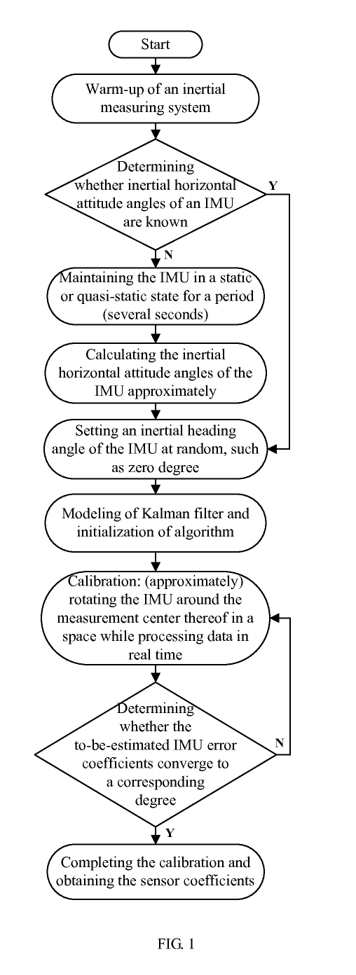

As shown in FIG. 1, an embodiment comprises the following steps that:

1) After an inertial measurement system is warmed up, whether the initial horizontal attitude angles of the IMU are known is determined. If yes, moving to Step 3; and if no, moving to Step 2. Attitude angles in the field include the horizontal attitude angles and the heading angle. In the embodiment, it can be directly determined whether the initial attitude angles of the IMU is known. If yes, moving to Step 4 directly; and if no, moving to Step 2. The known initial horizontal attitude angles or initial attitude angles can employ either an exact value or an approximate value.

2) The IMU is kept in a static state for a period, and the initial horizontal attitude angles of the IMU are calculated approximately according to the measurement information of the accelerometers and the gyros during the period. The static state is not strictly required in the invention, so that the IMU can be also kept in a quasi-static state for a period. In the embodiment, the IMU is fixed after warm-up of the inertial measurement system, and is kept in the static or quasi-static state for a period of 2 to 3 sec for initial alignment of the INS, wherein in the quasi-static state, the IMU generally static, and vibration, shaking and the like of the IMU motions caused by operation are allowed. According to the accelerometer and gyro information during the static or quasi-static period, the initial attitude angles of the IMU are calculated. The information output by the accelerometers can determine the horizontal attitude angles. A roll angle and a pitch angle are respectively determined via the formulas roll=sign(f_{z})sin⁻¹(f_{y}/g) and pitch=−sign(f_{z})sin⁻¹(fₓ/g), wherein fₓ, f_{y} and f_{z} are respectively specific-force outputs in the x-axis, y-axis and z-axis directions, g is the local gravity acceleration value, sign(•) is a sign function. Information output by the accelerometers at a certain time point can be selected as the specific-force value, or the average value of the accelerometer information in certain period can be used. Any method which is capable of determining the initial horizontal attitude angles of the IMU besides the above method can be employed. If the approximately horizontal attitude angles of the IMU are known, Step 2 can be skipped.

3) The initial heading angle of the IMU is set at random.

There are no requirements for the initial heading angle, and the initial heading angle needs not to be calculated, wherein the initial heading angle can be set at any value such as zero degree in the algorithm, can be generated randomly by a program, can be directly employed if the heading angle is known, or can be calculated via information output by the gyros.

And 4) the IMU is rotated around the measurement center thereof, and to-be-estimated gyro error coefficients (i.e. error coefficients including the biases and scale factors) and accelerometer error coefficients (i.e. error coefficients including the biases and scale factors) are calculated based on the known initial horizontal attitude angles or the initial horizontal attitude angles obtained in Step 2 and the initial heading angle obtained in Step 3. The obtained gyro and accelerometer error coefficients, i.e., the error coefficients of to-be-estimated sensors, are used for compensating the IMU outputs during working of the IMU. The IMU can get into the normal work state after Step 4 is completed.

When the IMU is fully rotated around (or approximately around) the measurement center thereof in the space, rotation motion is not strictly defined, wherein an accurate rotation angle (such as a rotation angle of 90 degree) and the accurate orientation (such as upward orientation of a certain axis) are not required, sufficiently without precision requirements can be employed. Completion of the rotation motion means completion of operation for the IMU. Precision of calibration can be correspondingly ensured by ergodic attitudes of the IMU.

The time length of the calibration motion can be set to ensure that the to-be-estimated IMU error coefficients converge to corresponding levels, and it is suggested to be about half of minute. In practical operation, operation with enough time can ensure the calibration precision; or whether the calibration motion is sufficient can be determined by use of different parameter information. For example, information (such as the standard deviation of the estimated IMU error coefficients) provided by the Kalman filter can be used for determining calibration progress in real time during calibration. A calibration result threshold is set by considering precision requirement of corresponding products. If information provided by the system reaches the precision requirement, the system can remind a user that the calibration is completed, and the calibration motion can be stopped.

A series of guidelines are provided on the basis of observable analysis on estimation of different sensor error coefficients under different motions. A user does not have to implement operations in strict accordance with the guidelines; however, the guidelines are helpful for substantially improving the calibration efficiency.

Calibration data can be processed in real time during the calibration process, or processed after the calibration is completed. The algorithm can be completed via an optimal method or a suboptimal estimation method (according to concrete conditions), such as Kalman Filter, Least Squares (or Weighted Least Squares) or other estimation methods.

If the calibration data is processed in real time, the Kalman Filter or Recursive Least Squares can be used as the estimation method. The accelerometer biases and scale factors and the gyro biases and scale factors can be constantly and timely estimated, fed back and corrected during the calibration process. Calibration is completed once rotation is completed, and post-processing is not required. In the process of calibration, completion progress of calibration is timely determined by information provided by the Kalman filter (such as the standard deviation of the estimated IMU error coefficients). Combined with precision requirement for corresponding products, a threshold is set for a calibration result. If information provided by the system reaches the precision requirement, the user is reminded of completion of calibration, and calibration can be stopped. After calculation of the Kalman filter is completed, filtering result can be combined with the whole segment of calibration data to carry out backward smoothing. Precise estimation result of the sensor error coefficients can be obtained via a weighted average of the result of the backward smoothing and the result of forward filtering.

If post-processing is employed, the estimated IMU error coefficients can be resolved within a short time after the user completes the motions. Other estimation methods such as Least Squares (or Weighted Least Squares) can be selected.

The estimation method selected in the invention can be modeled in advance to obtain the corresponding models. Taking the Kalman Filter as an example, state parameters include navigation states (position, velocity and attitude angle) or part of the navigation parameters, inertial sensor error coefficients and other parameters (such as auxiliary information provided by other sensors). The inertial sensor error coefficients can comprise both of the biases and the scale factors or either of the two. All the state parameters can employ error or non-error form. Any random process which is consistent with the actual situation, such as random constant, random walk or first order Gaussian Markov process can be used to model the to-be-estimated inertial sensor error coefficients.

Since the IMU is rotated around the measurement center thereof during calibration, positions of the measurement center of the IMU changes within a limited scope. Position variation and velocity variation of the IMU are both set as zero in the calibrating process, and are respectively used as pseudo-position observation information and pseudo-velocity observation information. Possible variation scopes of position and velocity in practical are given in the form of measurement noises. The measurement noise matrix can be set according to the actual operation, or be provided by the program adaptively. Due to employment of the pseudo-position observation information and pseudo-velocity observation information, it is not required to keep the IMU in static at different attitudes as in most calibration methods, and calibration efficiency and convenience are improved.

Both the pseudo-position observation information and pseudo-velocity observation information or either of the two can be used as measurement information. Besides the two, other motion characteristics of the IMU during the calibration process can be also used as pseudo observation. The pseudo-observation information can be used independently or combined with other calibration methods. If the calibrated object is a multi-sensor combined navigation system, information provided by other sensors can be used as measurement information. Pseudo-observation is within certain noise range, so that measurement noise can be used to represent possible inaccuracy of observed values, such as possible position and velocity variation scopes in the form of measurement noises.

In the calibration method, it is reflected that the accelerometers and the gyros calibrate each other, i.e., the accelerometer combination and the gyro combination can be seen as two systems, not only measurement information of the accelerometers can be used to calibrate and correct the gyro error coefficients, but also measurement information of the gyros can be used to calibrate and correct the accelerometer error coefficients.

Detailed steps are shown as follows, wherein description is mainly based on the Kalman filter algorithm, and description of the least squares method is similar to that of the Kalman filter algorithm.

Step 4.1) the whole calculation process of the Kalman filter calibration algorithm is modeled to obtain the calibration models. After modeling, the calibration algorithm is initialized (initial values of state parameters and initial state of the matrices which are used in the filter process are set), wherein initialization is related to a selected Kalman filter algorithm, and can be realized by automatic assignment via software technology. Different Kalman filters can be selected, and an augmented Kalman filter (AKF) is taken as an example while other Kalman filters are similar.

The state parameters used in the filter process can be represented by a Kalman filter state vector x in a vector form. It is suggested that to-be-estimated state in the Kalman filter is represented by an error form. The state parameters of the Kalman filter state vector x in the embodiment include navigation state errors and sensor errors, wherein the navigation state errors include all or some of position errors, velocity errors and attitude angle errors, and sensor errors include to-be-estimated gyro and accelerometer error coefficients, i.e., biases and scale factors of the accelerometers and biases and scale factors of the gyros.

Generally, initial values can be assigned to the state parameters of the Kalman filter state vector x before Kalman filter, and a covariance matrix composed of variances of the state parameters, a systematic state noise matrix and a measurement noise matrix can be initialized. It is suggested that the initial values of the state parameters of the Kalman filter state vector x are all set as zero. The variances of the navigation state errors can be set according to corresponding practical states. It is suggested that corresponding components of the to-be-estimated sensor error coefficients are set in reference to performance indexes of the sensors. The state noise matrix is set also in reference to performance indexes of the sensors. The measurement noise matrix represents the difference between a practical IMU position and the pseudo-position observation information in the embodiment as well as the difference between the practical IMU velocity and the pseudo-velocity observation information in the embodiment. Automatic data processing can be carried out in advance via the software technology, wherein a general measurement noise matrix is set to carry out filter calculation for a certain period, measurement noises are set according to filter results in the period, and filter calculation is carried out on data in the whole filter process to obtain the initial value of the measurement noise matrix. Realization of the Kalman filter algorithm is referred to Kalman filter and combined navigation principle by Qin Yongyuan etc., 1998, Northwestern Polytechnical University Press Co. Ltd.

The whole calibration process requires the following models:

Output errors of the gyros and the accelerometers can be respectively modeled as

δf^{b}=bₐ+diag(f^{b})δsₐ+wₐ (1)

δω_{ib}^{b}=b_{g}+diag(ω_{ib}^{b})δs_{g}+w_{g} (2)

δf^{b} and δω_{ib}^{b} are respectively the error vectors of specific forces and angular velocities, bₐ and b_{g} are respectively biases of the accelerometers and the gyros, δsₐ and δs_{g} are respectively scale factor errors of the accelerometers and the gyros, f^{b} and ω_{ib}^{b} are respectively true specific forces and angular velocities, wₐ and w_{g} are respectively pseudo noise items of the accelerometers and the gyros, and diag(v) represents a diagonal matrix which is formed by components in the vector v=[vₓ v_{y} v_{z}]^{T}:

$$diag ( v ) = [ \begin{matrix}{v}_{x} & 0 & 0 \\ 0 & {v}_{y} & 0 \\ 0 & 0 & {v}_{z}\end{matrix} ] \qquad ( 3 )$$

The initial value of the position is set according to the present coordinate, and the initial value of velocity is set as zero; initial values of the horizontal attitude angles are set as the known initial horizontal attitude angles or the initial horizontal attitude angles obtained in Step 2 and the initial heading angle obtained in Step 3; initial values of biases of the gyros and accelerometers are suggested to be set as 0; and scale factors of the gyros and accelerometers are suggested to be set as 1. The horizontal attitude angles and the heading angle in the field are both named as attitude angles, and if the initial attitude angles are known, the initial values of the horizontal attitude angles and the heading angle are assigned according to the value of the initial attitude angles. In other words, during real-time data processing, the first epoch uses the initial attitude angles, and then the latter epoch uses the attitude angles obtained in the former epoch.

The state equations of the Kalman filter are

$$\begin{matrix}δ {\dot{r}}^{c} = - {ω}_{ec}^{c} \times δ {r}^{c} + δ {v}^{c} & ( 4 ) \\ δ {\dot{v}}^{c} = {F}_{vr} δ {r}^{c} - ( 2 {ω}_{ie}^{c} + {ω}_{ec}^{c} ) \times δ {v}^{c} + {f}^{c} \times ψ + {C}_{b}^{p} δ {f}^{b} & ( 5 ) \\ \dot{ψ} = - ( {ω}_{ie}^{c} + {ω}_{ec}^{c} ) \times ψ - {C}_{b}^{n} δ {ω}_{ib}^{b} & ( 6 ) \\ {\dot{b}}_{a} = - \frac{1}{{τ}_{ba}} {b}_{a} + {w}_{ba} & ( 7 ) \\ {\dot{b}}_{g} = - \frac{1}{{τ}_{bg}} {b}_{a} + {w}_{bg} & ( 8 ) \\ δ {\dot{s}}_{a} = - \frac{1}{{τ}_{sa}} δ {s}_{a} + {w}_{sa} & ( 9 ) \\ δ {\dot{s}}_{g} = - \frac{1}{{τ}_{sg}} δ {s}_{g} + {w}_{sg} & ( 10 )\end{matrix}$$

The equations (4)-(6) model the navigation errors. Only states and physical quantities which are projected to a c-frame (the computer frame) are analyzed. In practical, the states and physical quantities can be projected to any other coordinate system, and analysis thereof is similar.

Wherein, δᵣ^{c}, δv^{c} and ψ are respectively projections of the position (latitude, longitude and altitude) error, velocity error and the attitude-angle rotation vector error in the c-frame (the computer frame); bₐ and b_{g} are the biases of the accelerometers and the gyros; δsₐ and δs_{g} are respectively scale factor errors of the accelerometers and the gyros, and δ\dot{r}^{c}, δ\dot{v}^{c}, \dot{ψ}, \dot{b}ₐ, \dot{b}_{g}, δ\dot{s}ₐ and δ\dot{s}_{g} successively represent time derivations of δr^{c}, δv^{c}, ψ, bₐ, b_{g}, δsₐ and δs_{g}.

f^{c} is the specific force vector projected to c-frame; ωᵢₑ^{c} and ω_{ec}^{c} respectively represent projections of the auto-rotational angular velocity of the earth and the rotational angular velocity of the c-frame relative to the e-frame in the c-frame; τ_{ba}, τ_{bg}, τₛₐ and τ_{sg} respectively represent correlation time of different sensor error coefficients; w_{ba}, w_{bg}, wₛₐ and w_{sg} are driven white noises; C_{b}^{p} represents the directional cosine matrix from the b-frame (the body coordinate system) to the p-frame (the platform coordinate system), and C_{b}ⁿ represents the directional cosine matrix from the b-frame to the n-frame (the navigation coordinate system); and indicates cross product of two vectors.

The Fᵥᵣ in equation (5) can be represented as

Fᵥᵣ=[−g/(R_{M}+h)−g/(R_{N}+h)2g/(R+h)] (11)

Wherein, R_{M} and R_{N} are respectively the radii of the meridian and the prime vertical of the earth; R=\sqrt{R_{M}R_{N}}; and g and h respectively represent the gravity value and the altitude.

Equations (7)-(10) model the to-be-estimated sensor error coefficients. First order Gauss-Markov Process is used for modeling. And other random processes such as random constant and random walk can be also used.

Measurement information of Kalman filter can make use of pseudo-position or pseudo-velocity, corresponding measurement models are

zᵣ=\hat{r}^{c}−\tilde{r}^{c}=δr^{c}+nᵣ (12)

zᵥ=\hat{v}^{c}−\tilde{v}^{c}=δv^{c}+nᵥ (13)

Wherein, \tilde{r}^{c}=constant, and \tilde{v}^{c}=0.

zᵣ and zᵥ are respectively position measurement vector and velocity measurement vector of Kalman filter; \hat{r}_{c} and \hat{v}^{c} are respectively position and velocity predicted by the Kalman filter state equations; \tilde{r}^{c} and \tilde{v}^{c} are the observation vectors of the pseudo-position and pseudo-velocity; δr^{c} and δv^{c} are position error and velocity error in the state vector; and nᵣ and nᵥ are the measurement noises.

If the pseudo-position and pseudo-velocity information are both used for constraint, the equations (12) and (13) are both used as measurement equations; and if the pseudo-position or pseudo-velocity information is used for constraint, the equation (12) or (13) is used as the measurement equation.

Especially, when only the pseudo-velocity information is used, position errors can be removed from the Kalman filter state vector, the equation (4) is removed from the state equations and F_{w}δr^{c} is removed from the equation (5).

In addition, the state equations can be simplified to some extent due to object and operation of the calibration method, wherein position of the IMU is approximately unchanged, velocity is approximately 0, and IMUs in middle and low precision are aimed. The equations (5) and (6) can be simplified as

δ\dot{v}^{c}=−(2ωₗₑ^{c}+ω_{ec}^{c})×δv^{c}+f^{c}×ψ+C_{b}^{p}δf^{b} (14)

\dot{ψ}=−(ωᵢₑ^{c}+ω_{ec}^{c})×ψ−C_{b}ⁿδω_{ib}^{b} (15)

Related parameters of Kalman filter are set. According to performance parameters of built-in IMU sensors of the calibration object, and items, related to the to-be-estimated error coefficients (biases and scale factors of the accelerometers as well as biases and scale factors of the gyros), in the filter state error covariance matrix (Q), the initial state vector (x) and the initial state covariance matrix (P) are set. In reference to practical calibration state, a measurement error covariance matrix (R), and items related to navigation error parameters (position, velocity and attitude angle errors) in x and P are set. Possible variation range of position and velocity of the IMU is embodied in the measurement error covariance matrix (R).

If the least squares method is used for estimation, the assignment process is modeled correspondingly. The to-be-estimated sensor error coefficients are used as to-be-estimated parameters; and pseudo-position and pseudo-velocity information are used as measurement information or constraint conditions. In practical operation, possible variation range of position and velocity is given in the covariance matrix.

Step 4.2) the IMU is rotated around the measurement center thereof and data is processed in real time via the calibration models. In the rotation process, the Kalman filter continuously predicts states and updates measurement, timely estimates the biases and scale factors of the accelerometers as well as the biases and scale factors of the gyros, and constantly carries out feedback and correction. A group of error state parameters is estimated based on the filtering, and values of present parameters including position, velocity and attitude angle are corrected according to the values of the group of parameters, and are then used as coefficients which are used in calculation of filtering in the next time.

If the least squares method is used for estimation, data is not processed in the step. Instead, it is only required to store outputs of the sensor in different time.

Step 4.3) according to index information provided in the Kalman filter, whether the parameters converge to a corresponding preset precision is judged; if yes, the step 4.4 is moved to; and if no, the step 4.2 is continued. If backward smoothing is used after calibration in the step 4.4, whether a preset precision A in a corresponding degree is converged to is judged, otherwise, the preset precision is B, wherein A is greater than B. Requirements for the object convergence degree are properly lowered.

If the least squares method is used for estimation, the index information cannot be obtained in the calibration process; instead, the calibration precision is ensured via rotation for enough time. Necessary operation time in the least squares method is C, and necessary operation time in Kalman filter is D, wherein C is less than D. Thus, the least squares method requires less operation time to ensure the same precision with that of the Kalman filter.

Step 4.4) after completion of calibration, the step 4.5 is directly moved to, or the step 4.5 is moved to after backward smoothing.

Backward smoothing is carried out after completion of filter calculation, which can further improve the precision of parameter estimation or shorten calibration time. If backward smoothing is required, state parameter values of the system and a covariance matrix of the values in each moment are required to be stored. The data stored in the filter process is utilized in backward smoothing, and state values of a new system are estimated in a maximum likelihood method. Results of forward filter and backward smoothing are weighted to maintain continuity and smoothness of the results as possible.

A fixed interval smoothing algorithm is taken as an example. Complete RTS smoothing equations include:

\hat{x}_{k|N}=\hat{x}_{k|k}+Aₖ(\hat{x}_{k+1|N}−\hat{x}_{k+1|k}) (16)

P_{k|N}=P_{k|k}+Aₖ(P_{k|N}−P_{k+1|k})Aₖ^{T} (17)

Wherein, the smoothing gain Aₖ is given as

Aₖ=P_{k|k}Φₖ^{T}(P_{k+1|k})⁻¹ (18)

k=N−1, N−2, . . . 0, and N represents the total times of measurement updates. Φ is the state transition matrix for a discrete-time Kalman filter; \hat{x} is the state vector; P is the covariance matrix of the state parameters; and the subscript j|i represents the optimal estimation of the state vector or the covariance matrix of the state parameters at the moment tⱼ when the measurement vectors z₁, z₂, . . . , zᵢ are used in calculation via a mathematical model.

And step 4.5) calibration is completed, and the to-be-estimated gyro and accelerometer error coefficients are obtained.

Based on the above steps, observability of the system can be analyzed, wherein the observability describes the capability of the system in estimating the to-be-estimated states, and also provides a series of guidelines. The calibration efficiency can be substantially improved when operations are carried out in accordance with the guidelines.

Detailed analysis on the observability comprises that:

The state equations can be simplified to some extent during observability analysis due to that the quick calibration method of the invention aims at medium- and low-grade IMUs and that positional change and linear velocity range of the IMU measuring center in the whole process are extremely limited. The observability analysis is carried out in the n-frame, and analysis in other frames is similar.

Pseudo-velocity is analyzed as an example. The simplified state equations are

δ\dot{v}ⁿ=fⁿ×ψⁿ+δfⁿ (19)

\dot{ψ}ⁿ=−δω_{ib}ⁿ (20)

\dot{b}ₐ=0 (21)

\dot{b}_{g}=0 (22)

δ\dot{s}ₐ=0 (23)

δ\dot{s}_{g}=0 (24)

Wherein, δ\dot{v}ⁿ, \dot{ψ}ⁿ, \dot{b}ₐ, \dot{b}_{g}, δ\dot{s}ₐ, and δ\dot{s}_{g} respectively represent time deviations of velocity errors, attitude-angle rotation vector errors, accelerometer biases, gyro biases, accelerometer scale factor errors and gyro scale factors error projected to the n-frame; ψⁿ is the attitude-angle rotation vector errors; and fⁿ is the specific force vector in the n-frame.

δfⁿ and δ∫_{ib}ⁿ are projections of specific forces and angular velocity errors to the n-frame:

δfⁿ=bₐⁿ+diag(fⁿ)δsₐⁿ+wₐⁿ (25)

δω_{ib}ⁿ=b_{g}ⁿ+diag(ω_{nb}ⁿ)δs_{g}ⁿ+w_{g}ⁿ (26)

bₐⁿ and b_{g}ⁿ respectively represent projections of the accelerometer biases and the gyro biases to the n-frame; δsₐⁿ and δs_{g}ⁿ respectively represent projections of the accelerometer scale factor errors and the gyro scale factor errors to the n-frame; wₐⁿ and w_{g}ⁿ are pseudo noise items of the accelerometers and gyros in the n-frame; and diag(v) represents the diagonal matrix which is formed by components in the vector v.

Since the IMU is not obviously displaced, the angular velocity ωᵢₙⁿ of the n-frame relative to the i-frame (the initial frame) is neglected.

The equations (24) and (25) are respectively substituted into the equations (19) and (20),

δ\dot{v}ⁿ=fⁿ×ψⁿ+bₐⁿ+diag(fⁿ)δsₐⁿ (27)

\dot{ψ}=−(b_{g}ⁿ+diag(ω_{nb}ⁿ)δs_{g}ⁿ) (28)

Thus, the measurement vector z=z_{V}, wherein zᵥ represents the velocity measurement vector.

It is supposed that xₐ(=[(δvᵤⁿ)^{T} (ψᵤⁿ)^{T} (bₐᵤⁿ)^{T} (δsₐᵤⁿ)^{T} (b_{gu}ⁿ)^{T} (δs_{gu}ⁿ)^{T}]) is not observation in the system. The subscript u in the following analysis denotes an unobservable part of corresponding state, i.e. Aᵤ denotes the unobservable part in state A. Time deviations in different steps of the measurement vector are successively calculated:

$$\begin{matrix}z = δ {v}_{u}^{n} = 0 & ( 29 ) \\ \dot{z} = {f}^{n} \times {ψ}_{u}^{n} + {b}_{au}^{n} + diag ( {f}^{n} ) δ {s}_{au}^{n} = 0 & ( 30 ) \\ \ddot{z} = {f}^{n} \times ( {b}_{gu}^{n} + diag ( {ω}_{nb}^{n} ) δ {s}_{gu}^{n} ) = 0 & ( 31 ) \\ {z}^{...} = {f}^{n} \times diag ( {\dot{ω}}_{nb}^{n} ) δ {s}_{gu}^{n} ) = 0 & ( 32 ) \\ {z}^{( 4 )} = 0 \\ ⋮ & ( 33 ) \\ {z}^{( k )} = 0 , k = 4 , 5 , … , n - 1 & ( 34 )\end{matrix}$$

A non-zero solution does not exist in the equation (29), so that the velocity error δvⁿ is always observable.

In the calibration method of the invention, the measurement center of the IMU does not move approximately, thus

fⁿ=[0 0 −g]^{T} (35)

Each in the n-frame is represented as vector components, i.e. vᵤⁿ=[v^{Nu} v_{Eu} v_{Du}]^{T}. The three elements respectively represent components in the northern, eastern and ground directions.

The equation (30) can be written as equations (36) to (38) as follows:

gψ_{Eu}+b_{aNu}=0 (36)

−gψ_{Nu}+b_{aEu}=0 (37)

b_{aDu}−gδs_{aDu}=0 (38)

According to the equations (36) and (37), unobservable parts (b_{aNu} and b_{aEu}) of the accelerometer biases in the northern and eastern directions are respectively correlated with unobservable parts (ψ_{Eu} and ψ_{Nu}) of the attitude angle errors in the eastern and northern directions. δs_{aDu} is an unobservable part of the accelerometer scale factor errors in the ground direction.

According to an equation (40), the attitude-angle rotation vector error ω_{D} in the ground direction is always unobservable due to the attitude-angle rotation vector error does not appear in the equation set. The unobservable part of the accelerometer bias in the ground direction b_{aDu} is correlated with gδs_{aDu}. However, biases of accelerometers in middle and low precision is higher than the gδs_{aDu} for multiple magnitude orders, i.e., b_{aD} is much greater than gδs_{aD}, so that b_{aD} is rapidly converged to equivalent level of gδs_{aD}, which means b_{aD} is strongly observable.

From the above, vertical accelerometer error coefficients are estimated, and horizontal attitude-angle errors can be further estimated.

Similarly, the equation (33) can be written as (39)-(40),

−g(b_{gNu}+ω_{N}δs_{gNu})=0 (39)

g(b_{gEu}ω_{E}δs_{gEu})=0 (40)

b_{gDu} and δs_{gDu} do not appear in the equations, which means that vertical gyro bias b_{gDu} and vertical gyro scale factor error δs_{gDu} are always unobservable. b_{gNu}, b_{gEu}, δs_{gNu} and δs_{gEu} respectively represent unobservable parts of northern gyro bias, eastern gyro bias, northern gyro scale factor error and eastern gyro scale factor error; and ω_{N} and ω_{E} are respectively northern rotation angular velocity and eastern rotation angular velocity.

If ω_{N}=0, northern gyro bias b_{gN} is observable, and northern gyro scale factor error δs_{gN} is unobservable; and similarly, if ω_{E}=0, eastern gyro bias b_{gE} is observable, and eastern rotation angular velocity δs_{gE} is unobservable. If ω_{N}≠0, b_{gNu} is correlated with ω_{N}δs_{gNu}; or if ω_{E}≠0, b_{gEu} is correlated with ω_{E}δs_{gEu}. Since b_{gN} is much greater than ω_{N}δs_{gN} and b_{gE} is much greater than ω_{E}δs_{gE}, b_{gN} or b_{gE} is strongly observable and rapidly converged to ω_{N}δs_{gN} or ω_{E}δs_{gE}.

The equation (34) can be written as equations (43)-(44),

−g\dot{ω}_{N}δs_{gNu}=0 (43)

g\dot{ω}_{E}δs_{gEu}=0 (44)

If \dot{ω}_{N}=0, δs_{gN} is unobservable; and if \dot{ω}_{N}≠0, δs_{gN} is observable. Similarly, the observability of δs_{gE} depends on whether \dot{ω}_{E} is zero. \dot{ω}_{N} and \dot{ω}_{E} respectively represent time deviations of the northern rotation angular velocity and eastern rotation angular velocity.

In conclusion, change of the angular velocity around the horizontal axis is helpful for estimation of the gyro scale factor in the corresponding axis, and further estimation of the corresponding gyro bias is enhanced. Simultaneously, rotation around the vertical axis is useless.

In accordance with the above observability analysis, guidelines are provided for operation:

1. The IMU is rotated around the horizontal axis as possible. Rotation around the horizontal axis is effective while rotation around the vertical axis is ineffective, i.e., not helpful for calibration. At the same time, forward and backward rotation can be used to widen output range of the gyro and enhance estimation of scale factors;

and 2. The IMU is made traverse different attitudes as possible because that an error parameter which is unobservable in one attitude is observable in another attitude.

A user does not have to implement operations in strict accordance with the guidelines; however, the guidelines are helpful for substantially improving the calibration efficiency.

Calibration tests and results are provided to elaborate effects of the quick calibration method for the IMU.

Two IMUs in different grades are respectively used in two operation modes to test the precision of the calibration method, wherein the two IMUs include a NovAtel SPAN-FSAS (www.novatel.com/assets/Documents/Papers/FSAS.pdf) and an Xsens MTi-G (www.xsens.com/en/general/mti-g), a high-end tactical IMU is built in the SPAN-FSAS, and the MTi-G is based on typical MEMS inertial sensors. Related performance parameters of the two IMUs are shown in Table 1.

TABLE 1

| | IMU | | | |
|---|---|---|---|---|
| Performance Parameters | SPAN-FSAS | | MTi-G ^{a} | |
| Sensor Grade | Tactical Grade | | MEMS | |
| Sensor Sampling Rate | 200 | Hz | 100 | Hz |
| Gyro Bias (1σ) | 0.75 | deg/h | 3600 | deg/h |
| Gyro White Noise(ARW) | 0.1 | deg/√h | 3.0 | deg/√h |
| Gyro Scale Factor Error (1σ) | <300 | ppm | — | |
| Accelerometer Bias (1σ) | 1000 | mGal | 2000 | mGal |
| Accelerometer White | <0.0005 | m/s²/√Hz | 0.002 | m/s^{2/}√Hz |
| Noise(VRW) | | | | |
| Accelerometer Scale | <1000 | ppm | 3000 | ppm |
| Factor Error(1σ) | | | | |

The purposes of using the two IMUs are given as follows:

1. It is required to know true values of the inertial sensor error coefficients, which are used as reference, to evaluate the calibration precision of the quick calibration method. Theoretically, the true values can be obtained in-lab through a highly precise calibration method such as a six-position method. However, error coefficients of medium- and low-grade IMUs, especially of an MEMS IMU, change greatly with temperature, so that a set of true values cannot be obtained to be used as reference values of the calibration results in all moments. A higher-grade IMU is introduced to solve the problem. The error coefficients of the FSAS are more stable than those of the IMUs in the middle and low precision for multiple magnitude orders. Thus, the FSAS can be used as an ideal error-free IMU after in-lab calibration and compensation. When the FSAS is calibrated via the quick calibration method of the invention, it can be considered that sensor error coefficients which are obtained finally are all caused by the quick calibration method. To further reflect practical conditions of the medium- and low-grade IMUs, typical errors of the IMU in middle and low precision are added into output of the ideal IMU artificially, so that an ideal medium- and low-grade IMU with known sensor error coefficients is obtained.

Concretely, the added errors of the medium- and low-grade IMUs include the gyro biases 1000 deg/h; the accelerometer biases 50000 mGal; and the sensor scale factor errors 5000 ppm. Errors of different axes are respectively represented by positive or negative signs for differentiation.

And 2. Use of the FSAS sufficiently verifies the precision of the quick calibration method, and the MTi-G is used as an embodiment to further confirm feasibility of the quick calibration method.

All the tests are completed artificially without external equipment. Two modes are accorded in the tests to verify different calibration manners, wherein in the different manners, the operation is carried out according to the above guidelines, or an unprofessional user implements the operation without guidance.

Mode 1: operation with guidance. Based on the above guidelines, the MTi-G is rotated around a horizontal IMU axis in each time to enhance observability of the parameters. Each gyro can be used as a rotating shaft when being approximately horizontal, and can be rotated clockwise and anticlockwise. Each accelerometer can be approximately upward or downward.

Mode 2: random operation. The random operation is used to reflect the actual precision of the calibration method when the operation is carried out by the unprofessional user. The IMU is completely rotated in hands without following any guideline.

The calibration results are given as follows:

(1) The FSAS is calibrated for 30 times under guidelines via the quick calibration method.

Table 2 shows the statistical results of the SPAN-FSAS in the Mode 1 (operation with guidance). In the Table 2, the first column shows the to-be-estimated sensor error coefficients, the second column shows the added error values, and the third and fourth columns respectively represent the inner precision and outer precision of the calibration results.

According to the Table 2, the inner precisions (standard, STD, repeatability) of the results for 30 times when the SPAN-FSAS is calibrated in the Mode 1 (operation with guidance) are approximately: the accelerometer biases 200 mGal, the accelerometer scale factor errors 300 ppm, the gyro biases 10 deg/h, and the gyro scale factor errors 200 ppm.

The outer precisions (root-mean-square, RMS, precision) are approximately: the accelerometer biases 400 mGal, the accelerometer scale factor errors 400 ppm, the gyro biases 10 deg/h, and the gyro scale factor errors 300 ppm. The outer precision can represent the precision of the quick calibration method in the mode.

TABLE 2

| To-be-estimated Error | Added Sensor | Inner Precision | Outer Precision |
|---|---|---|---|
| Coefficients (Unit) | Error Values | (STD) | (RMS) |
| bax (mGal) | +50000 | 137 | 396 |
| bay (mGal) | −50000 | 146 | 312 |
| baz (mGal) | +50000 | 112 | 240 |
| δsfax (ppm) | +5000 | 201 | 289 |
| δsfay (ppm) | −5000 | 234 | 336 |
| δsfaz (ppm) | +5000 | 196 | 397 |
| bgx (deg/h) | +1000 | 6 | 7 |
| bgy (deg/h) | −1000 | 8 | 10 |
| bgz (deg/h) | +1000 | 6 | 8 |
| δsfgx (ppm) | +5000 | 144 | 246 |
| δsfgy (ppm) | −5000 | 109 | 111 |
| δsfgz (ppm) | +5000 | 168 | 317 |

(2) The FSAS is calibrated for 30 times randomly via the quick calibration method.

Table 3 shows the statistical results of the SPAN-FSAS in the Mode 2 (random operation). In the Table 3, the first column shows the to-be-estimated sensor error coefficients, the second column shows the added error values, and the third and fourth columns respectively represent the inner precisions and outer precisions of the calibration results.

According to the Table 3, the outer precisions (RMS, precision) are approximately: the accelerometer biases 900 mGal, the accelerometer scale factor errors 600 ppm, the gyro biases 35 deg/h, and the gyro scale factor errors 400 ppm.

TABLE 3

| To-be-estimated Error | Added Sensor | Inner Precision | Outer Precision |
|---|---|---|---|
| Coefficients (Unit) | Error Values | (STD) | (RMS) |
| bax (mGal) | +50000 | 426 | 885 |
| bay (mGal) | −50000 | 274 | 523 |
| baz (mGal) | +50000 | 273 | 519 |
| δsfax (ppm) | +5000 | 523 | 555 |
| δsfay (ppm) | −5000 | 406 | 429 |
| δsfaz (ppm) | +5000 | 298 | 564 |
| bgx (deg/h) | +1000 | 14 | 15 |
| bgy (deg/h) | −1000 | 17 | 23 |
| bgz (deg/h) | +1000 | 24 | 35 |
| δsfgx (ppm) | +5000 | 205 | 352 |
| δsfgy (ppm) | −5000 | 59 | 59 |
| δsfgz (ppm) | +5000 | 226 | 348 |

And (3) The MTi-G is calibrated for 30 times randomly via the quick calibration method, which is used as the embodiment in which the unprofessional user implements the quick calibration method.

Table 4 shows the statistical results of the MTi-G in the Mode 2 (random operation). In the Table 4, the first, third and fourth columns respectively represent the to-be-estimated error coefficients, and the inner and outer precisions thereof; and the second column represent initial values of to-be-estimated errors.

According to the Table 4, the outer precisions (RMS, precision) of the MTi-G in the Mode 2 (random operation) are approximately: the accelerometer biases 1400 mGal, the accelerometer scale factor errors 1100 ppm, the gyro biases 140 deg/h, and the gyro scale factor errors 1200 ppm. The MTi-G employs the MEMS IMU, errors in the results comprise influence caused by temperature change. It is proved that the quick calibration method of the invention can be used for calibrating the IMUs in middle and low precision.

TABLE 4

| | Initial Values of | | |
|---|---|---|---|
| To-be-estimated | To-be-estimated | | |
| Sensor Error | Sensor Error | Inner Precision | Outer Precision |
| Coefficients (Unit) | Coefficients | (STD) | (RMS) |
| bax (mGal) | +50000 | 473 | 1364 |
| bay (mGal) | −50000 | 548 | 759 |
| baz (mGal) | +50000 | 598 | 773 |
| δsfax (ppm) | +5000 | 604 | 748 |
| δsfay (ppm) | −5000 | 855 | 1040 |
| δsfaz (ppm) | +5000 | 768 | 772 |
| bgx (deg/h) | +1000 | 119 | 140 |
| bgy (deg/h) | −1000 | 52 | 54 |
| bgz (deg/h) | +1000 | 82 | 140 |
| δsfgx (ppm) | +5000 | 834 | 845 |
| δsfgy (ppm) | −5000 | 281 | 447 |
| δsfgz (ppm) | +5000 | 305 | 1122 |

### CONCLUSION

The invention relates to the method for rapidly calibrating the error coefficients of the IMU. According to the method, the user holds and rotates the IMU to experience different attitudes without any external equipment, so that twelve error coefficients including the gyro biases, the gyro scale factors, the accelerometer biases and the accelerometer scale factors can be accurately calibrated in a short time (about 30 sec).

Table 5 shows calibration results in the two modes, wherein the first column shows the to-be-estimated sensor error coefficients, the second column shows the reached precision of tests in the Mode 1 (operation with guidance), and the third column shows the reached precision of tests in the Mode 2 (random operation).

According to the Table 5, the quick calibration method of the invention can accurately calibrate the medium- and low-grade IMUs. Due to that the quick calibration method for the IMU is characterized by being free of hardware cost, high in efficiency and simple and easy to implement, the method is especially suitable for in-situ quick calibration for the medium- and low-grade IMUs, thereby effectively solving the problem of environmental sensitivity (in particular temperature sensitivity) of the error coefficients of the MEMS IMU, and promoting popularization and application of MEMS inertial devices.

TABLE 5

| | Operation with | | Random | |
|---|---|---|---|---|
| Sensor Errors | Guidance(Mode 1) | | Operation(Mode 2) | |
| Accelerometer Biases | 400 | mGal | 900 | mGal |
| Accelerometer Scale Factors | 400 | ppm | 600 | ppm |
| Gyro Biases | 10 | deg/h | 35 | deg/h |
| Gyro Scale Factors | 400 | ppm | 400 | ppm |

Embodiments in the invention are only used as examples to elaborate the quick calibration method, and can be modified, supplemented or replaced by similar manners by technical staff in the field; however, the key to the quick calibration method or the scope defined in the claims is not deviated.

What is claimed is:

1. A quick calibration method for an inertial measurement unit (IMU), characterized in comprising the following steps that:
Step 1) after an inertial measurement system is warmed up, whether an initial horizontal attitude angle of the IMU is known is determined; if yes, moving to Step 3; and if no, moving to Step 2;
Step 2) the IMU is maintained in a static state for a period and the initial horizontal attitude angle of the IMU is calculated approximately according to measurement information of an accelerometer and a gyro during the period;
Step 3) an initial heading angle of the IMU is set at random; and
Step 4) the IMU is rotated around a measurement center thereof, and to-be-estimated gyro and accelerometer error coefficients are calculated based on the known initial horizontal attitude angle or the initial horizontal attitude angle obtained in Step 2 and the initial heading angle obtained in Step 3, wherein during calculation, position variation and velocity variation of the IMU are both set as zero, and respectively represent pseudo-position observation information and pseudo-velocity observation information.

2. The quick calibration method for the IMU as defined in claim 1, wherein processes of maintaining the IMU in the static state in Step 2 and rotating the IMU around the measurement center thereof in Step 4 are realized via manual operation or by means of other equipment and machines.

3. The quick calibration method for the IMU as defined in claim 1 or 2, wherein calibration and calculation in Step 4 are realized by the Kalman filter algorithm, particularly comprising:
Step 4.1) modeling the whole calculation process of the Kalman filter algorithm to obtain a calibration model, setting initial values of relative parameters in the calibration model based on the known initial horizontal attitude angle or the initial horizontal attitude angle obtained in Step 2 and the initial heading angle obtained in Step 3, and initializing the calibration algorithm;
Step 4.2) rotating the IMU around the measurement center thereof, and processing data in real time via the calibration model;
Step 4.3) judging whether the to-be-estimated IMU error coefficients converge to a corresponding preset precision; if yes, moving to Step 4.4, and if no, continuing implementing Step 4.2;
Step 4.4) after completion of calibration, moving to Step 4.5 directly, or moving to Step 4.5 after once backward data smoothing; and
Step 4.5) obtaining the to-be-estimated gyro and accelerometer error coefficients after calibration.
